(19) United States
(12) Patent Application Publication
(10) Pub. No.: US 2026/0351989 A1
(43) Pub. Date: Nov. 5, 2026

(54) REMOTE CHARGING OF PULSED POWER DRILLING TOOLS

(71) Applicant: Halliburton Energy Services, Inc., Houston, TX (US)

(72) Inventor: Nagaraja K. Pai, Lancaster, PA (US)

(21) Appl. No.: 19/284,000

(22) Filed: Jul. 29, 2025

Related U.S. Application Data
(60) Provisional application No. 63/798,801, filed on May 2, 2025.

(51) Int. Cl. H02J 7/34; E21B 4/04; E21B 17/02; E21B 17/22; H02J 7/50; H02J 7/90

(52) U.S. Cl. CPC H02J 7/345; E21B 4/04; E21B 17/023; E21B 17/22; H02J 7/50; H02J 7/933; H02J 2207/50

(57) ABSTRACT

A pulsed power drilling system and method. An electrical cable is selected for a wellbore and inserted through or alongside a drill string or coiled tubing. The impedance of the selected electrical cable is modeled as a plurality of electrical cable segments arranged in series. A surface impedance network is connected to an uphole end of the electrical cable. The surface impedance network matches the modeled impedance for the selected electrical cable at the uphole end of the electrical cable. A downhole impedance network that matches the modeled impedance for the selected electrical cable at a downhole end of the electrical cable is connected to the downhole end of the electrical cable.

### BACKGROUND

Pulsed power drilling in subterranean formations involves using a drill bit on which, for example, one or more sets or pairs of electrodes are disposed. The pairs of electrodes may be oriented along a face of the drill bit, with a gap between each electrode in a set. The passage of the electrical current between the electrodes of a set and through the rock causes the rock to break up into monomineralic grains. The process generally results in the faster generation of ore and finer monomineralic grains than with purely mechanical drilling processes.

Pulsed power drilling fluid may be pumped through the downhole tool at the bottom of the wellbore and up through the annulus between the drill string and the wellbore. As with rotary bit drilling, the pulsed power drilling fluid may bring drill cuttings upward through the annulus and may provide a hydrostatic head to prevent a blowout. A pulsed power drilling fluid will preferably have a high dielectric constant, low conductivity, high dielectric strength, and a long life under industrial or military application environments.

### BRIEF DESCRIPTION OF THE DRAWINGS

Embodiments of the disclosure may be better understood by referencing the accompanying drawings.

FIG. 1 is an elevation view in partial cross section of an example pulsed power drill system, according to aspects of the present disclosure.

FIG. 2 is an elevation view in partial cross section of another example pulsed power drill system, according to aspects of the present disclosure.

FIG. 3 is a block diagram illustrating another example of a pulsed power drill system, according to aspects of the present disclosure.

FIG. 4 is a block diagram illustrating an example pulsed power drill impedance network, according to aspects of the present disclosure.

FIG. 5 is a circuit diagram illustrating an example surface impedance network which may be used in the systems shown in FIGS. 2-4, according to aspects of the present disclosure.

FIG. 6 is a circuit diagram illustrating an example downhole impedance network which may be used in the systems shown in FIGS. 2-4, according to aspects of the present disclosure.

FIG. 7 is a circuit model illustrating another example downhole impedance network which may be used in the systems shown in FIGS. 2-4, according to aspects of the present disclosure.

FIG. 8 is a circuit model illustrating an electrical cable connected to a surface impedance network and a downhole series impedance network and switch, according to aspects of the present disclosure.

FIG. 9 is a circuit model illustrating an electrical cable connected to a surface impedance network and a downhole parallel impedance network and switch, according to aspects of the present disclosure.

FIG. 10 is a block diagram illustrating a computer system that may be used as part of the system and method for determining a surface impedance network and a downhole impedance network in the example well system of FIGS. 1-3, according to aspects of the present disclosure.

FIG. 11 is a flow chart illustrating a method of deploying a pulsed power drill, according to aspects of the present disclosure.

FIG. 12 is a flow chart illustrating another method of deploying a pulsed power drill, according to aspects of the present disclosure.

Like reference numbers and designations in the various drawings indicate like elements.

### DETAILED DESCRIPTION

The description that follows includes example systems, methods, techniques, and program flows that embody embodiments of the disclosure. Unless otherwise specified, use of the terms “connect,” “engage,” “couple,” “attach,” or any other like term describing an interaction between elements is not meant to limit the interaction to a direct interaction between the elements and may also include an indirect interaction between the elements described. Unless otherwise specified, use of the terms “up,” “upper,” “upward,” “uphole,” “upstream,” or other like terms shall be construed as generally away from the bottom, terminal end of a well; likewise, use of the terms “down,” “lower,” “downward,” “downhole,” or other like terms shall be construed as generally toward the bottom, terminal end of the well, regardless of the wellbore orientation. Use of any one or more of the foregoing terms shall not be construed as denoting positions along a perfectly vertical axis. In some instances, a part near the end of the well can be horizontal or even slightly directed upwards. Unless otherwise specified, use of the term “subterranean formation” shall be construed as encompassing both areas below exposed earth and areas below earth covered by water such as ocean or fresh water.

Pulsed power drilling (PPD) tools need a power source and a charging system to charge its primary capacitor. One current approach to pulsed power drilling includes placing a medium voltage power supply at the surface and placing a booster, charger, and a pulsed power converter in the bottom hole assembly (BHA). There are multiple challenges present in the current system. For example, packaging of dual power conversion stages and resonant power transfer devices across a Tesla transformer may result in dramatic losses in power and may require complex BHA designs. The more complex a BHA design the less maneuverable and robust it may be. This may constrain well plans and effective reservoir outreach. In addition, it may be challenging for downhole components to isolate high voltages and electrical field concentrations from magnetically permeable formations. The current scheme may also be susceptible to large power losses and increased temperature rise.

What is described below is a pulsed power drilling system that moves power generation to the surface, simplifying the design of the BHA by eliminating a medium to high voltage power conversion stage in the BHA, thus reducing cost and increasing reliability. In one example approach, an electrical cable passing through a drill string or through coiled tubing connects a power generator at the surface to a pulsed power drill in the BHA. In one example approach, the BHA includes a pulsed power drill, directional control, and Logging While Drilling (LWD) tools. In one such example approach, the cable further carries auxiliary power and communication from the surface to the BHA.

The electrical cable presents an impedance to the surface power generator and to the BHA. The impedance changes with cable length. In some example approaches, the cable impedance presents as predominately capacitive to the surface power generator and a predominately inductive to the BHA. Without impedance matching, pulsing on the electrical cable may lead to oscillations.

In one example approach, the power generator at the surface includes a surface impedance connected between the power supply and the cable. In one such example approach, the surface impedance network filters out inductive voltage swings in the electrical cable resulting from current interruptions. In one example approach, a complementary impedance network at the BHA receives the power from the cable and transfers the power to the pulsed power drill bit. The described approach reduces or eliminates high voltage oscillations in the system which may be detrimental to the operation of the system and operator safety.

In one example approach, an isolation switch is added to the surface impedance network. The isolation switch isolates the PPD's resonant pulse transfer operation from the cable impedance.

In one example approach, a series switch is added to the BHA. The series switch electrically connects and disconnects the surface-based high voltage power source and the pulsed power drill.

In one example approach, the electrical cable connecting the surface power generator to the BHA is a high voltage cable. The high voltage cable may replace a medium voltage cable. In one example approach, the high voltage cable may support voltages between 10 kV-1,000 kV.

Illustrative examples are given to introduce the reader to the general subject matter discussed herein and are not intended to limit the scope of the disclosed concepts. The following sections describe various additional features and examples with reference to the drawings in which like numerals indicate like elements, and directional descriptions are used to describe the illustrative aspects, but, like the illustrative aspects, should not be used to limit the present disclosure.

### Example Well Systems

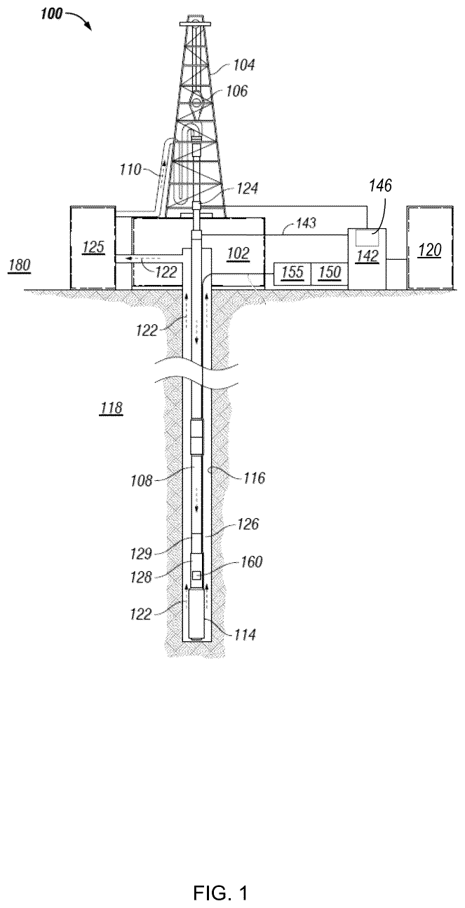

FIG. 1 is an elevation view in partial cross section of an example pulsed power drill system, according to aspects of the present disclosure. In the example shown in FIG. 1, the exemplary pulsed power drilling (PPD) system 100 may be used to form a wellbore in a subterranean formation. Although FIG. 1 shows land-based equipment, downhole tools incorporating teachings of the present disclosure may be satisfactorily used with equipment located on offshore platforms, drill ships, semi-submersibles, and drilling barges (not expressly shown). Additionally, while wellbore 116 is shown as being a generally vertical wellbore, wellbore 116 may be any orientation comprising generally horizontal, multilateral, or directional.

In the example shown in FIG. 1, a drilling platform 102 is assembled on a surface 180. The surface 180 includes the area of the drilling platform 102, the area adjacent to the drilling platform 102, and any land or structure relevant to hydrocarbon extraction using the drilling platform 102.

In the example shown in FIG. 1, PPD system 100 includes a drilling platform 102 that supports a derrick 104 having a traveling block 106 for raising and lowering a drill string 108. Drill string 108 may be raised and lowered using a draw-works driven hydraulically or by a power source, such as an electric motor (not shown), to spool-in a wire rope used to raise and lower the drill string 108. The draw-works may comprise a crown block which, together with traveling block 106, form a block and tackle with several windings of the wire rope between them for mechanical advantage. In one example approach, sensors mounted on or proximate to the draw-works spool measure the rotation, from which changes in the depth of the drill string may be calculated.

In one example approach, time may be measured and, together with the calculations of changes in depth, may enable the calculation of instantaneous and average rates of penetration (ROP) of the formation 118. PPD system 100 may also include mud pump 125, which circulates drilling fluid 122 (also called “mud”) through a feed pipe to kelly 110, which in turn conveys drilling fluid 122 downhole through interior channels of drill string 108 and through one or more fluid flow ports in pulsed power drill bit 114. Drilling fluid 122 circulates back to the surface via an annulus 126 formed between drill string 108 and the sidewalls of wellbore 116. Fractured portions of the formation (also called “cuttings”) are carried to the surface by drilling fluid 122 to remove those fractured portions from wellbore 116. Drilling fluid 122 and cuttings returning from downhole to the surface may flow over a shale shaker or another device that removes the cuttings from drilling fluid 122. The portion of drilling fluid 122 returned from downhole to the surface may be collected in surface tanks and may be evaluated by personnel or through automated fluid management systems, after which an adjustment to drilling fluid may be initiated. For example, a person or automated system may examine, and subsequently initiate an adjustment to, properties of drilling fluid 122 that may have changed while in wellbore 116. In some example approaches, sensors may be employed at the surface 180, e.g., at the shale shaker or along the flow lines through which drilling fluid 122 is returned to the surface, to examine the properties of the cuttings and drilling fluid 122 returned to the surface. In some example approaches, gas entrained in drilling fluid 122 or cuttings may be captured and analyzed by personnel, or the volume and/or other characteristics of the entrained gas may be directly measured by sensors at the surface 180.

In some example approaches, the drilling fluid 122 may have rheological properties useful for removing cuttings from wellbore 116. Drilling fluid 122 may also have electrical properties conducive to particular PPD operations. Drilling fluid 122 may include oil-based fluids or water-based fluids, depending upon the particular pulsed power drilling approach used. Drilling fluid 122 may also be formulated to have high dielectric strength and a high dielectric constant, so as to direct electrical arcs from the pulsed power drill bit 114 to the formation 118 rather than short the arcs in the drilling fluid 122.

As shown in FIG. 1, PPD system 100 may include a valve 124 at the surface 180. In one example approach, valve 124 is used to create pressure pulses, sometimes referred to as mud pulses, in drilling fluid 122. The pressure pulses may, in some example approaches, be used to convey commands or other information to various downhole components. The pressure pulses, or mud pulses, may be sensed by a sensor at the BHA, e.g., a pressure sensor ported to the flow path of drilling fluid 122 through the BHA tubular elements. The resulting sensor signals may inform or be translated (e.g., by a processor) into commands used in controlling a PPD operation. The resulting sensor signals may be translated by various actuators into other types of control signals used to control a PPD operation. In one example approach, valve 124 may be positioned anywhere along the flow path of drilling fluid 122 from mud pump 125 to the start of drill string 108.

In one example approach, pulsed power drill bit 114 is attached to the distal end of drill string 108. Pulsed power drill bit 114 may be an electrocrushing drill bit or an electrohydraulic drill bit. Power may be supplied to pulsed power drill bit 114 from components downhole, components at the surface and/or a combination of components downhole and at the surface. For example, power generator 120 may generate electrical power and provide that power to power-conditioning unit 142. Power-conditioning unit 142 may then transmit electrical energy downhole via an electrical cable 143 run down the wellbore 116 (contained, for example, within drill string 108 or attached to the outer wall of drill string 108). In one example approach, power-conditioning unit 142 includes a surface impedance network 146 connected to electrical cable 143.

A pulse generating (PG) circuit 160 within BHA 128 may receive the electrical energy from power-conditioning unit 142 and may generate high-energy electrical pulses to drive pulsed power drill bit 114. The high-energy electrical pulses may discharge through the rock formation and/or drilling fluid 122 and may provide information about the properties of the formation and/or drilling fluid 122. In one example approach, PG circuit 160 includes a downhole impedance network (not shown) connected directly to electrical cable 143. Surface impedance network 146, electrical circuit 143 and the downhole impedance network form a single impedance network geared to smooth transmission of power to the pulsed power drill bit 114, as will be discussed in further detail below.

In one example approach, PG circuit 160 may be integrated into BHA 128 and may be located near pulsed-power drill bit 114. In some such example approaches, PG circuit 160 may include a power source input having two input terminals, and a first capacitor coupled between the input terminals.

In one example approach, pulse generating circuit 160 within BHA 128 may be utilized to repeatedly apply a large electric potential across the electrodes of pulsed-power drill bit 114. For example, the applied electric potential may be in the range of 150 kV to 300 kV or higher. When the electric potential across the electrodes of pulsed-power drill bit 114 is increased enough to generate a sufficiently high electric field, an electrical arc forms at the distal end of drill string 108. The arc allows electric current to flow through a portion of the rock formation 118 at the distal end of drill string 108. The arc greatly increases the temperature and pressure of the portion of the rock formation 118 through which the arc flows and the surrounding rock formation 118 and materials. The temperature and pressure are sufficiently high to break the rock into small bits referred to as cuttings. This fractured rock is removed, typically by the drilling fluid 122, which moves the fractured rock away from the electrodes and uphole.

The arc may also generate acoustic and/or electromagnetic waves that are transmitted within rock formation 118 and/or drilling fluid 122. Sensors placed within wellbore 116 and/or on the surface may record responses to high-energy electrical pulses, acoustic waves, and/or electromagnetic waves. Sensor analysis system (SAS) 150 may, during PPD operations, receive measurements representing the recorded responses and may analyze the measurements to determine characteristics of rock formation 118 or for other purposes. PPD system 100 may also include a mud pulsed valve downhole; the mud pulsed valve may be controlled to create pressure pulses in drilling fluid 122 that convey information to various components upstream.

In one example, an optical fiber may be positioned inside a portion of wellbore 116 and a distributed acoustic sensing subsystem may sense the pressure pulses based on changes in strain on the optical fiber and translate them into electrical signals that are provided to sensor analysis system (SAS) 150, Other types of pressure sensing mechanisms at the surface may detect the pressure pulses and translate them into electrical signals that are provided to SAS 150. Pulsed drilling controller (PDC) 155 may determine that a current operating parameter of a PPD operation should be modified based on the analysis performed by SAS 150 and may output a control signal to adjust a configurable downhole components (CDCs) that directly or indirectly affects the operating parameter to be modified.

In one example approach, wellbore 116 is extended as pulsed power drill bit 114 repeatedly fractures the rock formation and drilling fluid 122 removes the fractured rock uphole. Wellbore 116 may be any hole formed in a subterranean rock formation 118 or series of subterranean rock formations 118 for the purpose of exploration or extraction of natural resources such as, for example, hydrocarbons, or for the purpose of injection of fluids such as, for example, water, wastewater, brine, or water mixed with other fluids. Additionally, wellbore 116 may be any hole formed in a subterranean formation or a series of subterranean formations for the purpose of geothermal power generation.

Although pulsed-power drill bit 114 is described above as implementing electrocrushing drilling, pulsed-power drill bit 114 may also be used for electrohydraulic drilling. In electrohydraulic drilling, rather than generating an electrical arc within the rock, pulsed-power drill bit 114 applies a large electrical potential across the one or more electrodes to form an arc across the drilling fluid proximate to the distal end of wellbore 116. The high temperature of the arc vaporizes the portion of the drilling fluid immediately surrounding the arc, which in turn generates a high-energy shock wave in the remaining fluid. The electrodes of electrohydraulic drill bit may be oriented such that the shock wave generated by the arc is transmitted toward the distal end of wellbore 116. When the shock wave contacts and bounces off the rock at the distal end of wellbore 116, the rock fractures. Accordingly, wellbore 116 may be formed in subterranean formation 118 using pulsed-power drill bit 114 that implements either electrocrushing or electrohydraulic drilling. The circuit topologies used for electrohydraulic drilling may be the same as, or close to, those used for electrocrushing drilling with at least some components of the circuits having different values.

In one example approach, SAS 150 may be positioned at the surface for use with PPD system 100 as illustrated in FIG. 1, or at any other suitable location. Any suitable telemetry mechanism (not illustrated) may be used for communicating signals between downhole components and surface-based components. For example, telemetry mechanism may be used for communicating signals from various acoustic, electrical, or electromagnetic sensors at the surface or downhole to SAS 150 during a PPD operation.

PDC 155 may determine whether or when modifications should be made to the operating parameters of a PPD operation and may initiate the adjustment of CDCs that directly or indirectly affect any operating parameters that are to be modified without the need for those components to be removed from wellbore 116. For example, PDC 155 may initiate real-time adjustments to CDCs of a PPD system in response to changing conditions during a drilling operation. By making real-time adjustments, the number of times that all or a portion of drill string 108 is removed from wellbore 116 may be reduced and the ROP achieved during PPD operations may be improved.

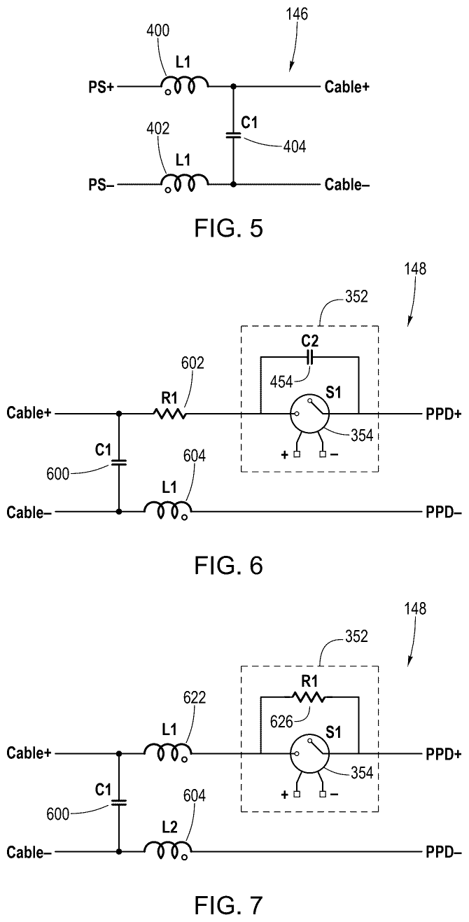

In one example approach, PDC 155 may be coupled to, or otherwise in communication with, SAS 150. Alternatively, the functionality of SAS 150 may be integrated within PDC 155, with PDC 155 acting as a master controller for PPD operations. An example PDC that comprises an integrated SAS is illustrated in FIG. 5 and described below. Signal or informational inputs to PDC 155 may comprise measurements received from both downhole and surface sensors, or results of calculations made based on those measurements, indicating ROP, characteristics of cuttings, characteristics of drilling fluid 122 returning from downhole to the surface and/or entrained gas; downhole measurements of hole caliper or quality, vibration, or other wellbore characteristics; formation measurements; fluid pressure measurements; wellbore direction measurements; wellbore tortuosity or dogleg severity; and measurements of parameters within the pulsed-power tool itself, such as power draw, voltages, currents, frequencies, or wave forms measured within the tool at various sensing points, some of which may be associated with one or more particular electronic components.

The downhole operating environment is typically a high temperature environment, and the temperature may affect the performance, survival, and required maintenance cycles of the various electronic and other components of a pulsed-power tool. In addition, the operation of these components for pulsed power drilling may generate heat and may further raise the temperature of the environment and the components themselves. The temperature of a pulsed-power tool may be measured at one or more locations. Temperature measurements for a pulsed-power tool may be obtained using temperature sensors coupled to or proximate to components of the pulsed-power tool. These temperature measurements may be useful for controlling operations in accordance with operating and/or survival specifications and intended operating points, for calculating component efficiency and/or for detecting incipient failure.

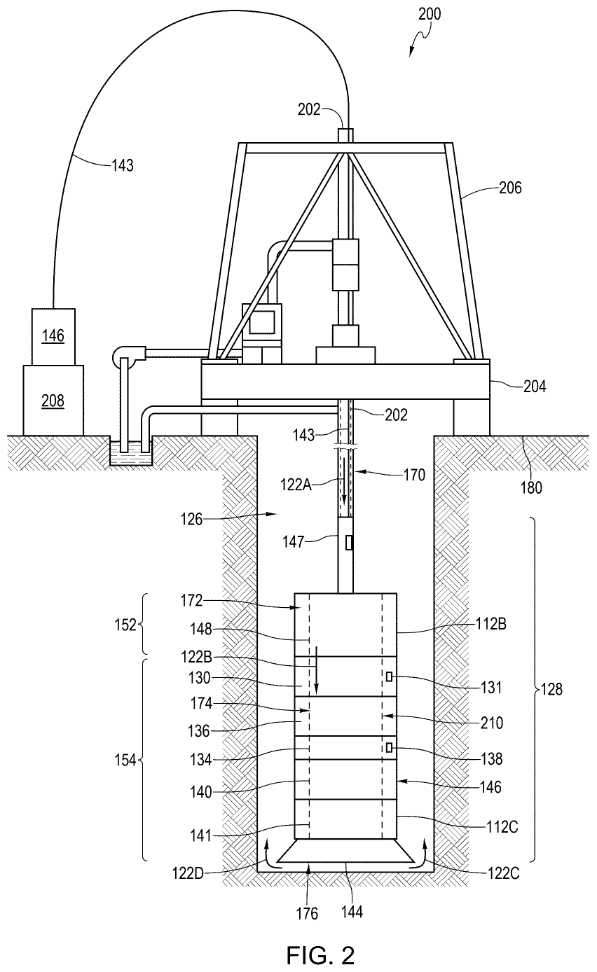

FIG. 2 is an elevation view in partial cross section of another example pulsed power drill system, according to aspects of the present disclosure. In the example shown in FIG. 2, an example pulsed power drilling system 200 may perform or be used to perform the example pulsed power drilling (PPD) operations discussed above, and the operations 170, 172, 174 and 176 described below. The example pulsed power drilling operations 170, 172, 174 and 176 are described in more detail below (after the description of the different parts of the example pulsed power drilling system 200).

Pulsed power drilling (PPD) systems (100, 200) need a power source and a charging system for the primary capacitor 136. The power source may be either hydraulic (based on drilling fluid) or electric. While the hydraulic powered PPD that uses a turbine-alternator power conditioner is compatible with traditional drill-pipe based drilling, a coiled tubing-based drilling system such as shown in FIG. 2 allows for the transfer of electric power directly to the PPD when a suitable cable and a charging system is added.

In one example approach electrical power is transmitted from a power supply at the surface 180 to the primary capacitor 136 via an electrical cable 143. The electrical cable 143 may run through or adjacent to the coiled tubing 202 shown in FIG. 2. In contrast to conventional wellbore drilling, which uses a drill bit having rotating cutting elements to cause a cutting (fracturing or crushing) of rock, pulsed power drilling typically extends the wellbore using discharges of electric pulses In some example approaches, the pulses may include short duration, periodic, high-voltage pulses that are discharged through the rock in a surrounding formation. Such discharges may create an internal pressure which applies a tensional stress substantial enough to break or fracture the rock in tension. In some example approaches, pulsed power drilling creates a plasma in the drilling fluid or rock downhole which functions as a high-energy discharge. The creation of the plasma downhole may involve injecting large amounts of energy into the subsurface formation. Thus, pulsed power drilling may require substantial amounts of both voltage and current for successful breakage or fracturing of rock in a downhole environment.

The BHAs 128 in FIGS. 1 and 2 may be configured to further the advancement of the wellbore 116 by pulsing electrical power generated by a power supply 208 at the surface 180 and transmitted to electrodes 144 via the electrical cable 143. The electrodes 144 may be configured to emit an electrical discharge through formation material of a subsurface formation along the bottom face of the wellbore 116 and in the nearby proximity to the electrodes 144. The cable 143 may be capable of supplying power from the power supply 208 at an order of magnitude which provides for the creation of the plasma upon pulse discharges into the formation. The electrical cable 143 may also be capable of transmitting enough power such that an electrical discharge emitted into the formation creates enough internal pressure to destroy the rock in the formation.

The example pulsed power drilling system 200 shown in FIG. 2 includes a drilling platform 204, with a framework 206 positioned to receive coiled tubing 202 and to direct the coiled tubing 202 into a wellbore 116. The example pulsed power drilling system 200 shown in FIG. 2 also includes a BHA 128 positioned in wellbore 116 and coupled to coiled tubing 202. The coiled tubing 202 may comprise one or more strings of coiled tubing 202 sourced from one or more coiled tubing reels (not shown). Two or more strings of the coiled tubing 202 may be coupled together to reach a target depth in the wellbore 116. Remote charging of the PPD capacitor simplifies the pulsed power drilling tool considerably by eliminating a medium to high voltage power conversion stage in the BHA. This reduces the cost and enhances reliability. While depicted on the surface 180 as an onshore drilling operation, example implementations may also be performed as an offshore drilling operation.

In some example approaches, the electrical cable 143 may comprise a single conductor cable or a multiconductor cable. To convey electrical power, the cable 143 may be configured to supply high-voltage direct current (DC) power to the electrodes 144. In some implementations, a fiber optic cable or a coaxial communication cable may be part of a multiconductor cable configuration used to transmit data between the surface 180 and the BHA 128. Alternatively or in addition, a fiber optic cable or a coaxial communication cable may be a separate cable that is conveyed downhole within or alongside the coiled tubing 202. Using a cable rather than using other communication mediums (e.g., mud pulse telemetry) may enable high speed communication with equipment at the surface 180. The cable(s) 143 may utilize a single solid cable, a solid multi-cable configuration, or stranded cables that are configured to have a low inductance.

It can be difficult to convey an electrical cable 143 to depth with a traditional segmented drill pipe. Coiled tubing 202, however, allows not only for the cable 143 to be housed within the tubing 202 but also for conveying drilling fluid 122 (or mud) from the surface 180 downhole to the electrodes 144 to provide cooling to the electrodes 144 and to, for example, remove cuttings. In one example approach, each coiled tubing reel may include up to 5,000 ft of coiled tubing, although various sizes of reels may be used, whereas a stand of segmented drill pipe (typically comprising three or four individual joints) may be between 30-55 ft in length. Thus, the segmented drill pipe of FIG. 1 may require an additional drill pipe to be added for every 30-55 ft of drilling; running an electrical cable within the drill string 108 in FIG. 1 in this configuration may prove difficult.

The use of continuous tubing such as the coiled tubing 202 shown in FIG. 2 allows the drilling of longer wells. Furthermore, by extending the electrical cable 143 through or alongside of two or more strings of coiled tubing 202, the BHA 128 may receive consistent, direct DC power from the power supply 208 via the cable 143 across long distances. This sustained level of power may enable the BHA 128 to extend the wellbore 116 up to 2-3 miles vertically. The BHA 128 and the electrodes 144, with the benefit of consistent, high voltage DC power, may be capable of extending the wellbore 116 up to 7 miles laterally, which may not be feasible with intermittent power sources used in other pulsed power drilling operations. The electrical cable 143 may be as long as 50,000 ft. As further described below, the constant supply of high voltage DC power may be used to power one or more downhole operations in addition to drilling the wellbore 116. For example, DC power output from the power supply 208 may be used to power one or more of the following: nuclear magnetic resonance (NMR) operations, mud pulsing, geosteering equipment, measurement-while drilling (MWD) equipment, etc.

In one example approach, power supply 208 charges the PPD primary capacitor 136 through the impedance of electrical cable 143. The cable impedance appears as a complex network of inductances, capacitances, and resistances. The trapped energy in the cable during the charging process may be comparable to the peak energy in the PPD primary capacitor 136. Furthermore, the PPD operation may be affected by the cable impedance due to its resonant nature. To address this, in one example approach, additional impedance networks are added, as required, to modify the effective cable impedance to be favorable to the energy flow from power source 208 to the BHA 128. In one example approach, a capacitance dominant network is added at the up-hole end of the cable and a dissipative inductance dominant network is added at the downhole end of the cable. This approach substantially reduces the high voltage oscillations in the cable caused by the PPD operation. In addition, in some example approaches, an isolation switch is added at the up-hole end of the BHA 128. This isolates the PPD's resonant pulse transfer operation from the influence by the cable impedance.

In one example approach, therefore, a cable model is used to characterize performance of the electrical cable 143 over a given distance (e.g., 100-500 m). In one cable model approach, electrical cable 143 is treated as multiple cable sections connected in series. In one such approach, each section is 500 meters in length, as will be discussed in further detail below.

The combination of a surface impedance network 146 and a downhole impedance network 148, each connected to an end of electrical circuit 143, reduces the effects of cable length on energy delivery. This feature is advantageous for any pulsed power drilling application but is especially advantageous when cable lengths extend further than 4 miles, or when deep drilling for thermal reservoir access in geothermal drilling.

In some implementations, the cable 143 may be pre-assembled within the coiled tubing 202. In other implementations, the cable may be mounted to or strapped to the outside of the coiled tubing 202. While delivering high power to the electrodes 144, the cable(s) 143 may be properly supported within or against the coiled tubing 202 to withstand a fast-flowing drilling fluid, both for inflow of drilling fluid (122A and 122B) down the coiled tubing 202 and an outflow of drilling fluid (122C and 122D) up the annulus 126. For example, drilling fluid sent down the coiled tubing 202 may be highly viscous and under high pressure. Accordingly, the coiled tubing 202 and the cable 143 may form a mud-flow pipe that also delivers electrical power to the BHA 128.

Using the cable 143 to transmit the electrical power to the BHA 128 may also improve the thermal efficiency of the system. For example, a downhole power source, motor, or generator may concentrate heat losses at a single area in the wellbore 116 (within a 75-100 ft interval). Drilling fluid 122 in the area may be heated beyond a desired temperature, and the drilling fluid may require cycling out of the wellbore 116 at a quicker rate. Heat losses from the cable 143, however, may be distributed more evenly in the wellbore 116 (i.e., across the entire length of the cable 143. The distributed heat losses from the cable 143 may regularize thermal management in the wellbore 116 and enable a higher rate of penetration (ROP) of the BHA 128. Lower heat losses may enable the pulsed power section 154 to operate more efficiently, which may enable the electrodes 144 to arc into the formation (thus, drilling the formation) at an increased rate. In addition to minimizing heat losses, the pulsed power drilling system 200 may also be configured to minimize power losses. By using electrical cable 143, system 200 eliminates the need for a complex power conversion apparatus at or near the BHA 128. The power topology shown includes the power supply 208, the cable 143, and the primary capacitor 136 may reduce power losses during the delivery of a required charge to the electrodes 144 when compared to more traditional PPD systems. Impedance networks (146, 148) at the power supply 208 and the BHA 128, respectively, further tune the efficiency of the power transfer through the electrical cable 143.

As illustrated in FIG. 2, the BHA 128 may include multiple sub-assemblies, including, in some implementations, a downhole impedance network 148 at a top of the BHA 128. The top of the assembly is a face of the BHA 128 furthest from a drilling face of the BHA 128 (which contains the electrodes 144). The downhole impedance network 148 may be configured to reduce ripples in current and/or voltage output from the power supply 208 and along the cable 143.

The BHA 128 may additionally include a pulsed power controller 130, a switch bank 134 (including one or more switches 138), one or more primary capacitor(s) 136, a pulse transformer 140 with one or more primary and secondary windings, one or more secondary capacitors 141, and the electrodes 144. In some implementations, the power supply 208 (at the surface 180), the cable 143, downhole impedance network 148, power conditioning section 152 and pulse power section 154 (located in the wellbore 116) may be referred to as a power delivery system.

In some implementations, the coiled tubing reel(s) configured to store the coiled tubing 202 at the surface 180 have an increased inductance when compared to the cable 143 and BHA 128 in the wellbore 116. This increased inductance may occur because the cable 143 is wound within or otherwise with the coiled tubing 202 in the reel. The inductance of the coiled tubing reel may increase with the number of turns the coiled tubing 202 and the cable 143 make around the reel. As more coiled tubing 202 is conveyed into the wellbore 116, the inductance may decrease over time. The difference in inductance at the reel and the cable 143 in the wellbore 116 may induce a voltage overshot and/or ringing from the power supply 208 when transmitting pulsed power to the capacitors 136, 141. A downhole impedance network 148, coupled in series with the cable 143, surface impedance network 146 and power supply 208, may be configured to reduce the ringing caused by such inductance variations.

In one example approach, DC power output from the power supply 208 may be stored in the capacitors 136, 141 prior to a discharge criteria being satisfied. For example, a discharge or load criteria may be that a defined amount of energy has been stored. As an example, this criteria may be satisfied when the primary capacitor(s) 136 is fully charged. In another example, this criteria may be satisfied when the amount of energy that has been stored is sufficient to break the rock in the current subsurface formation. Accordingly, the amount of energy needed may vary depending on the type of rock. In another example, the criteria may be that a bottom of the pulsed power drill string is in contact with a bottom of the wellbore 116. This may include any contact or some defined amount of surface area of the bottom of the pulsed power drill string being in contact. In another example, the discharge criteria may be a defined amount of time since a prior electrical discharge.

In some example approaches, the power may continue to be supplied to and by the cable 143 after the primary capacitor(s) 136 is fully charged. After the amount of energy stored in the primary capacitor(s) 136 exceeds a defined amount (e.g., fully charged), a switch within switch bank 134 may be opened to prevent additional storage of energy in the primary capacitor(s) 136 until the energy is discharged therefrom to generate a pulse of electrical discharge emitted into the subsurface formation. The switch may then be closed to again allow for storage of energy in the primary capacitor(s) 136.

In the example shown in FIG. 2, the BHA 128 is divided into a power conditioning section (PCS) 152 and a pulsed power section (PPS) 154. The PCS 152 may include the downhole impedance network 148. The power supply 208 may be configured to deliver medium voltage or high voltage DC power to PCS 152, which in turn sends power to charge one or more capacitors (136, 141) of the pulsed power section 154. The pulsed power section 154 may include the pulsed power controller 130, the switch bank 134 (and switch(es) 138), the one or more primary capacitor(s) 136, the pulsed transformer 140, the one or more secondary capacitors 141, and the electrodes 144. Components may be divided between the power conditioning section 152 and the pulsed power section 154 in other arrangements, and the order of the components may be other than shown.

A center flow tubing 210 may be coupled to an end of the coiled tubing 202 and may travel through the BHA 128, acting as a conveyance tubing. In some implementations, the center flow tubing 210 may be a shorter section of coiled tubing configured to extend through both PCS 152 and pulsed power section 154. A flow of drilling fluid 122A (illustrated by the arrow pointing downward within the coiled tubing 202) may be provided from the drilling platform 204, and flow to and through the power conditioning section 152 and pulsed power section 154 of the BHA 128, as indicated by the arrow for the location and direction of flow of drilling fluid 122B. The PCS 152 may further process and controllably provide the electrical power to the rest of the downstream BHA 128. The stored power may then be output from the electrodes 144 to perform the advancement of the wellbore 116 via periodic electrical discharges. In some implementations, pulsed power drilling (achieved by the periodic electrical discharges) may be capable of advancing the wellbore by 60 to 128 feet per hour through one or more hard rock (i.e., consolidated) subsurface formations. By using the coiled tubing 202, the pulsed power drilling may avoid issues with forming connections between joints of segmented drill pipe. The use of the coiled tubing 202 and electrodes 144 for pulsed power drilling may also eliminate the need for multiple trips to change the drill bit.

In some example approaches, the drilling fluid 122 used in the wellbore 116 may include a dielectric drilling fluid. The dielectric drilling fluid may be a mixture of drilling mud and one or more dielectric sands which may grant the drilling fluid dielectric properties. While the dielectric sands may increase the viscosity of the drilling fluid, the dielectric properties may ensure that electrical discharges emitted from the electrodes 144 do not propagate up the wellbore 116 or to the surface 180.

In the example approach shown in FIG. 2, the drilling fluid 122 flows through the BHA 128, as indicated by drilling fluid 122B, and flows out and away from the electrodes 144 and back toward the surface to aid in the removal of the debris generated by the breaking up of the formation material at and nearby the electrodes 144. The fluid flow direction away from the electrodes 144 is indicated by the arrows indicating the location and direction of flow of drilling fluids 122C and 122D. In addition, the flow of the drilling fluid 122 may provide cooling to one or more devices and to one or more portions of the BHA 128. In various implementations, it is not necessary for the BHA 128 to be rotated as part of the drilling process, but some degree of rotation or oscillations of the BHA 128 may be provided in various implementations of drilling processes utilizing the BHA 128.

The flow of drilling fluid 122 passing through the BHA 128 may continue to flow through the center flow tubing 210, which thereby provides a flow path for the drilling fluid 122 through one or more sub-sections or components of the PCS 152 and the PPS 154, as indicated by the arrow pointing downward through the cavity of the sections of the center flow tubing 210. Once arriving at the electrodes 144, the flow of drilling fluid may be expelled out from one or more ports or nozzles located in or in proximity to the electrodes 144. After being expelled from the BHA 128, the drilling fluid may flow back upward toward the surface through an annulus 126 created between the BHA 128 and walls of the wellbore 116.

In one example approach, the center flow tubing 210 may be located along a central longitudinal axis of the BHA 128 and may have an overall outside diameter or outer shaped surface that is smaller in cross-section than the inside surface of a tool body 145 in cross-section. As such, one or more spaces may be created between the center flow tubing 210 and an inside wall of the tool body 145. These one or more spaces may be used to house various components, such as components which make up the downhole impedance network 148, a sensor 129, the pulsed power controller 130, the switch bank 134, the one or more switches 138, the one or more primary capacitor(s) 136, the pulsed transformer 140, and the one or more secondary capacitors 141, as shown in FIG. 2. The sensor 129 may be in different locations within the BHA 128. As depicted in FIG. 2, the sensor 129 is positioned near the pulsed power controller 130. However, the sensor 129 may be in any location within the BHA 128 and may include more than a single sensor (depending on the size and sensor measurement). Other components may be included in the spaces created between the center flow tubing 210 and the inside wall of the tool body 145. In some examples, a section 112B of tool body 145 and a section 112C of tool body 145 are used for PCS 152 and pulsed power section 154, respectively. In one such example, sections 112B and 112C may be constructed to allow PCS 152 to be separated from pulsed power section 154 when needed without removing tool body 145.

The example pulsed power drilling system 200 may include one or more logging tools 147. The logging tool(s) 147 are shown as being coupled to the coiled tubing 202 within the BHA 128. In some implementations, the logging tool 147 may be located above the BHA 128 or may be joined via a shop joint or field joint to BHA 128. The logging tool(s) 147 may include one or more logging while drilling (LWD) or measurement while drilling (MWD) tools, including, for example, a resistivity tool, a gamma-ray tool, and nuclear magnetic resonance (NMR) tool. The logging tools 147 may include one or more sensors to collect data downhole. For example, the logging tools 147 may include, for example, pressure sensors and flowmeters. The example pulsed power drilling system 200 may also include directional control, such as for geosteering or directional drilling, which may be part of the BHA 128, the logging tool(s) 147, or located elsewhere on the coiled tubing 202.

In one example approach, communication from the pulsed power controller 130 to the pulsed power controller 130 allows the pulsed power controller 130 to transmit data about and modifications for pulsed power drilling to the power conditioning section 152. Similarly, communications from the pulsed power controller 130 to the pulsed power controller 130 may allow the power conditioning section 152 to transmit data about and modifications for pulsed power drilling to the pulsed power section 154. The pulsed power controller 130 may control the discharge of the pulsed power stored for emissions out from the electrodes 144 and into the formation, into drilling mud, or into a combination of formation and drilling fluids. The pulsed power controller 130 may measure data about the electrical characteristics of each of the electrical discharges—such as power, current, and voltage emitted by the electrodes 144. Based on information measured for each discharge, the pulsed power controller 130 may determine information about drilling and about the electrodes 144, including whether the electrodes 144 are firing into the formation (i.e., drilling) or firing into the formation fluid (i.e., electrodes 144 are off bottom). The power conditioning section 152 may control the charge rate and charge voltage for each of the multiple pulsed power electrical discharges. The PCS 152, with electrical power supplied via the cable 143 may create an electrical charge in the range of 10-20 kilovolts (kV), which the pulsed power controller 130 delivers to the formation via the electrodes 144.

In some example approaches, the pulsed power controller 130 may communicate with the power conditioning section 152, enabling the power conditioning section 152, for instance, to ramp up and ramp down in response to changes or electrical discharge characteristics detected at the pulsed power controller 130. Because the load on the power conditioning section 152 is large (due to the high voltage), ramping up and ramping down in response to the needs of the pulsed power controller 130 may protect the power conditioning section 152 and associated components from load stress and may extend the lifetime of components of the pulsed power drilling assembly. If the pulsed power controller 130 is unable to communicate with the power conditioning section 152, then the power conditioning section 152 may apply a constant charge rate and charge voltage to the electrodes 144.

In instances where the BHA 128 is off bottom, electrical power input to the system may be absorbed (at least partially) by drilling fluid 122, which may be vaporized, boiled off, or destroyed because of the large power load transmitted in the electrical pulses. In instances where the BHA 128 is not operating correctly, such as when one or more switches experience a fault or require a reset, application of high power to the primary and/or secondary capacitors 136/141 or the electrodes 144 may damage circuitry and switches when applied at unexpected or incorrect times. In these and additional cases, communication between the pulsed power controller 130 and the power conditioning section 152 may allow the entire BHA 128 to, for instance, vary charge rates and voltages. In cases where the pulsed power controller 130 and power conditioning section 152 are autonomous, i.e., not readily in communication with the surface, downhole control of the BHA 128 may improve pulsed power drilling function.

Pulsed power drilling operations may include various operations. For example, such an operation may include pulsing of an electrical discharge to extend the wellbore 116 (e.g., electro-crushing). Another example operation may include pulsing of an electrical discharge while the drill string is off bottom for testing or formation evaluation. Another example operation may include pulsing of an electrical discharge for communication.

A series of example pulsed power drilling operations 170-176 within pulsed power drilling system 200 are now described. A first operation 170 includes transmitting electrical power generated from the power supply 208 down the cable 143 within the coiled tubing 202. The cable 143 may be mounted within the coiled tubing 202 to accommodate a flow of drilling fluid 122A during a pulsed power drilling operation. A second operation 172 includes conditioning the electrical power. For example, the downhole impedance network 148 may smooth the electrical power input from the cable 143, and a boost charger in PCS 152 may increase a voltage of the electrical power. Conditioning of the electrical power may also include altering or controlling one or more electrical parameters associated with the received electrical power including, but not limited to voltage, current, phase, and frequency.

A third operation 174 includes storing the conditioned electrical power. The electrical power may be stored in a primary capacitor 136 of the pulsed power section 154. The downhole impedance network 148 is configured to output conditioned DC electrical power received from the cable 143 to a boost charger in PCS 152. The electrical power may be stored in the primary capacitor(s) 136 while switch(es) in the switch bank 134 are open.

As further described below, a pulsed electrical discharge may be periodically output from the electrode(s) 144 to perform pulsed power drilling. A switch 138 of the switch bank 134 may remain open until a sufficient amount of power has been stored in the primary capacitors 136. After a sufficient amount of power has been stored in the primary capacitors 136, the switch 138 may be closed to supply power to the pulsed transformer 140 and the secondary capacitors 141 (through an inductor 218), which is then emitted from the electrode(s) 144 as a pulse of electrical discharge into the subsurface formation for pulsed power drilling. For example, another switch 138 may be closed when the primary capacitor(s) 136 storing the energy are fully charged. Alternative or additional criteria may be used to determine when to close the switch(es) 138, as further described below.

A fourth operation 176 includes pulsing an electrical discharge into the rock of the subsurface formation. For example, the pulsed power controller 130 may determine whether at least one discharge criteria has been satisfied. The discharge criteria may be a criteria that a defined amount of energy has been stored in the primary capacitor(s) 136. For example, the discharge criteria may be that the primary capacitor(s) 136 are fully charged, or that the primary capacitor(s) 136 are charged more than a defined percentage of the full storage capacity (e.g., 99%, 95%, 90%, 50%, etc.), etc.

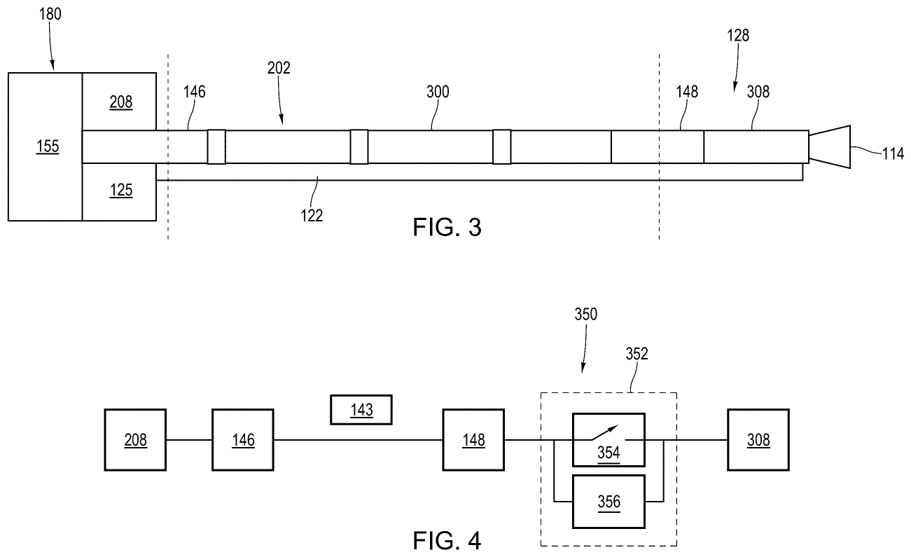

FIG. 3 is a block diagram illustrating another example of a pulsed power drill system, according to aspects of the present disclosure. In the example approach shown in FIG. 3, the example pulsed power drilling system is split into three sections, surface equipment, cable equipment and pulsed power equipment. The surface equipment includes an electrical power source 302, a mud pump 125, and PDC 155, all located at or near the surface 180.

The electrical circuit equipment includes the electrical cable 143, coiled tubing 202, the surface impedance network 146 and the downhole impedance network 148. The surface impedance network 146 is connected between the power supply 208 and the cable 143 to filter out any inductive voltage swings resulting from current interruptions. The downhole impedance network 148 is connected between the electrical cable 143 and the pulsed power equipment to damp oscillations at the downhole impedance network 148. The combination of the surface impedance network 146, the electrical cable 143 and the downhole impedance network 148 reduces or eliminates high voltage oscillations in the system 200 that may be detrimental to the operation of the system and to operator safety.

The pulsed power equipment includes the pulsed power drill (PPD) 308 and the drill bit 114. In some example approaches, the pulsed power equipment may also include telemetry/steering equipment 149 and logging/measuring while drilling tool 147. In operation drilling fluid 122 flows through coiled tubing 202 and BHA 128 to cool the pulsed power equipment.

In some example approaches, the electrical cable 143 delivers power, aux power and communication to the BHA 128. In one example approach, the BHA 128 also includes a series switch connected between the downhole impedance network 148 and the PPD 308. The switch connects and disconnects the surface-based high voltage power source 208 and the pulsed power drill (PPD) 308.

The combination of the coiled tubing 202 and the electrical cable 143 may be modeled for impedance as sections 300 of coiled tubing 202 and electrical cable 143. In some example approaches each cable section 300 includes 500 meters of electrical cable 143; the cable model is then modeled as a set of cable sections 300 connected in series over the length of the electrical cable 143. The surface impedance network 146 is then selected to filter out any inductive voltage swings resulting from current interruptions in a cable 143 modeled as a series of 500-meter sections of cable 143 connected in series.

FIG. 4 is a block diagram illustrating an example pulsed power drill impedance network, according to aspects of the present disclosure. In the example pulsed power drill impedance network 350 shown in FIG. 4, a surface power supply 208 is connected to a surface impedance network 146. Surface impedance network 146 is designed to match the cable model of electrical cable 143. In one example approach, the surface impedance network 146 is connected between the power supply 208 and the electrical cable 143 to filter out any inductive voltage swings resulting from current interruptions. In one example approach, such as shown in FIG. 3, the electrical cable 143 runs through the coiled tubing 202 to downhole impedance network 148 and, from the downhole impedance network 148 to the pulsed power drill 308. In some example approaches, a switch network 352 is connected between the downhole impedance network and the pulsed power drill 308 to allow system 200 to connect and disconnect the surface-based high voltage power source 208 and the pulsed power drill 154. In the example approach of FIG. 4, switch network 352 includes a switch 354 in parallel with a capacitive impedance network 356.

In one example approach of the pulsed power drill impedance network, power supply 208 includes a capacitor charging power supply working in constant current mode. In another example approach, power supply 208 includes a voltage source power supply. In yet another example approach, power supply 208 is a power source capable of constant current and constant power modes for faster charging.

FIG. 5 is a circuit diagram illustrating an example surface impedance network which may be used in the systems shown in FIGS. 2-4, according to aspects of the present disclosure. In some example approaches, the surface impedance network 146 is basically capacitive in nature to balance the inductive cable impedances. In the example shown in FIG. 5, surface impedance network 146 includes two inductors (400, 402) connected to a capacitor (404). As noted above, the surface impedance network 146 is connected between the power supply 208 and the electrical cable 143 to filter out any inductive voltage swings resulting from current interruptions. In one example approach, such as shown in FIG. 3, the electrical cable 143 runs through the coiled tubing 202 to downhole impedance network 148. In another example approach, the electrical cable 143 extends alongside the coiled tubing 202 through annulus 126 to downhole impedance network 148. The combination of the coiled tubing 202 and the electrical cable 143 may be modeled for impedance as sections of coiled tubing 202. As noted above, in some example approaches each section is 500 meters in length; the cable model is then modeled as a series of cable sections 300 connected in series over the length of the electrical cable 143. The values of inductor 400, inductor 402 and capacitor 404 are then selected to filter out any inductive voltage swings resulting from current interruptions in a cable 143 modeled as a series of 500 m sections of cable connected in series.

FIG. 6 is a circuit diagram illustrating an example downhole impedance network which may be used in the systems shown in FIGS. 2-4, according to aspects of the present disclosure. In the example shown in FIG. 6, downhole impedance network 148 includes a resistor 602 and an inductor 604 connected to a capacitor 600. In one example approach, downhole impedance network 148 further includes a switch network 352 connected in series with resistor 602. In one such example approach, the switch network 352 includes a capacitor 454 connected in parallel with a switch 354. The switch 354 connects and disconnects the surface-based high voltage power source 208 and the pulsed power drill 154. In the example shown in FIG. 6, the downhole impedance network 148 is a series resistance type of impedance network.

FIG. 7 is a circuit model illustrating another example downhole impedance network which may be used in the systems shown in FIGS. 2-4, according to aspects of the present disclosure. In the example shown in FIG. 7, downhole impedance network 148 includes a first and second inductor (622 and 604, respectively) connected to a capacitor 600. In one example approach, downhole impedance network 148 further includes a switch network 352 connected in series with inductor 622. In one such example approach, the switch network 352 includes a resistor 626 connected in parallel with a switch 354. The switch 354 connects and disconnects the surface-based high voltage power source 208 and the pulsed power drill 154. In the example shown in FIG. 7, the downhole impedance network 148 is a parallel resistance type of impedance network.

The impedance networks of FIGS. 4-7 include inductors and capacitors. In addition, resistors may be used in the downhole impedance networks 148 to limit inrush currents during the turn-on of the switch 354 and to limit the voltage spikes during the turn-off of the switch 354.

In one example approach, the downhole impedance network may be of either of the two options: a series resistance type (FIG. 6) and a parallel resistance type (FIG. 7). The series resistance type of impedance network shown in FIG. 6 exhibits much higher power losses (approximately 30%) than the parallel resistance type, but it eliminates the influence of the cable 143 on the PPD's resonant operation. The parallel impedance network shown in FIG. 6 has much lower losses (approximately 10%) but can influence the resonant nature of the PPD pulse.

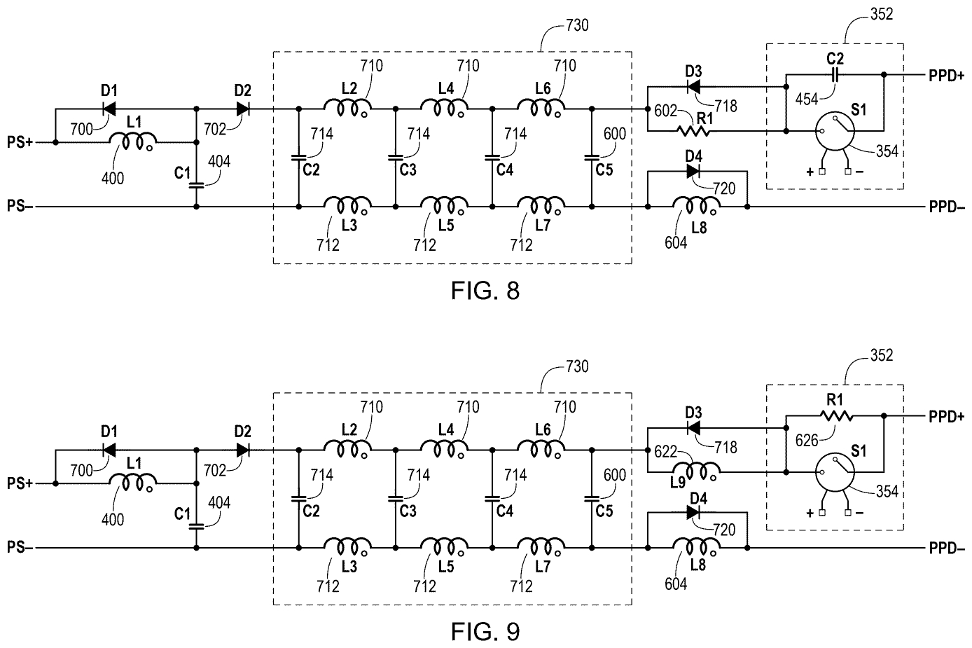

FIG. 8 is a circuit model illustrating an electrical cable connected to a surface impedance network and a downhole series impedance network and switch, according to aspects of the present disclosure. In the example shown in FIG. 8, a surface impedance network 146 is connected through the electrical cable 143 to a downhole series impedance network 148. Both the surface impedance network 146 and the downhole series impedance network 148 are derived from an impedance model 730 of the electrical cable 143. In the example shown in FIG. 8, the surface impedance network 146 includes an inductor 400 connected to a capacitor 404, a diode 700 and a diode 702. One polarity of the electrical cable 143 is connected to a terminal of capacitor 404 while another polarity of electrical cable 143 is connected to the output of diode 702.

In the example shown in FIG. 8, electrical cable 143 is modeled as a series of sections 300, where each section 300 is represented by a capacitor 714 and two inductors (710, 712). In one example approach, each section 300 of electrical cable 143 modeled is 100 to 500 m in length. Although three sections 300 are shown in FIG. 8, in actual conditions, the cable impedance model 730 may require thousands of sections 300 arranged in series. Downhole, the electrical cable 143 in FIG. 8 is connected across capacitor 600 to resistor 602 and inductor 604. A switch network 352 receives the output of downhole series impedance network 148 and connects and disconnects power supply 208 and the pulsed power drill 154 as detailed in the discussion of FIG. 7 above.

In the example shown in FIG. 8, diodes 718 and 720 limit voltage across resistor 602 and inductor 604, respectively.

FIG. 9 is a circuit model illustrating an electrical cable connected to a surface impedance network and a downhole parallel impedance network and switch, according to aspects of the present disclosure. In the example shown in FIG. 8, a surface impedance network 146 is connected through the electrical cable 143 to a downhole series impedance network 148. Both the surface impedance network 146 and the downhole parallel impedance network 148 are derived from the impedance model 730 of the electrical cable 143. In the example shown in FIG. 9, the surface impedance network 146 includes an inductor 400 connected to a capacitor 404, a diode 700 and a diode 702. One polarity of the electrical cable 143 is connected to a terminal of capacitor 404 while another polarity of electrical cable 143 is connected to the output of diode 702.

In the example shown in FIG. 9, electrical cable 143 is modeled as a series of sections 300, where each section 300 is represented by a capacitor 714 and two inductors (710, 712). In one example approach, each section 300 of electrical cable 143 modeled is 100 to 500 m in length. Although three sections 300 are shown in FIG. 8, in actual conditions, the cable impedance model 730 may require thousands of sections 300 arranged in series. Downhole, the electrical cable 143 in FIG. 9 is connected across capacitor 600 to inductor 622 and inductor 604. A switch network 352 receives the output of downhole series impedance network 148 and connects and disconnects power supply 208 and the pulsed power drill 154.

In operation, the systems shown in FIGS. 8 and 9, switch 354 is initially open, allowing a charge to build in capacitor 600. Once capacitor 600 is charged to the desired voltage, switch 354 is closed and the power is delivered to the primary capacitor 136 in BHA 128. The power delivered to the primary capacitor 136 may be, in some examples, be a combination of energy stored in capacitor 600 and energy stored in electrical cable 143. In one example, the energy stored in capacitor 600 may be approximately 1000-2000 Joules, while the energy stored in the electrical cable 143 may be approximately 100 Joules. Once the primary capacitor is charged as desired, switch 354 reopens to charge capacitor 600 again.

In the example shown in FIG. 9, diodes 718 and 720 limit voltage across resistor 602 and inductor 604, respectively.

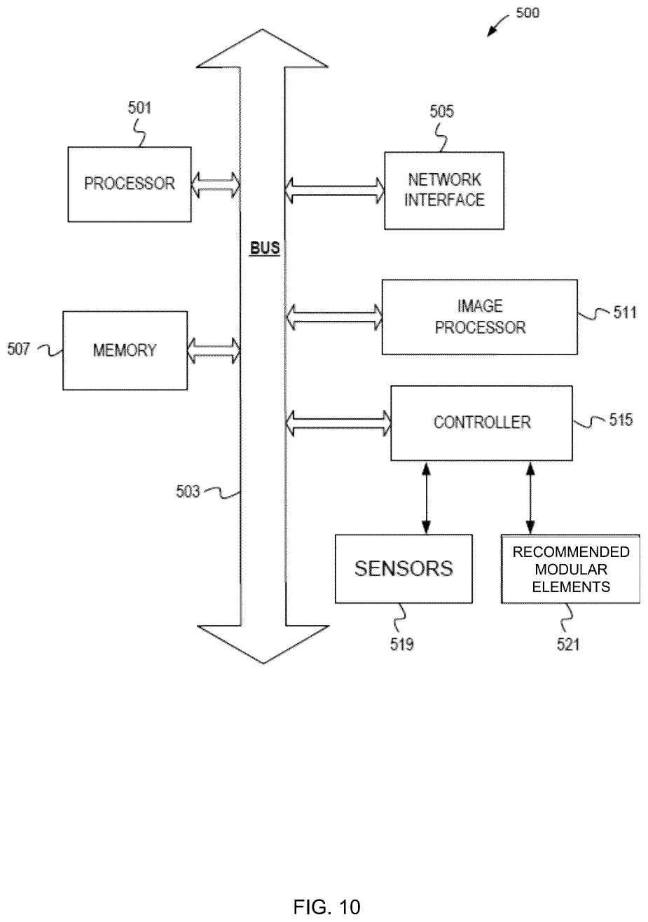

FIG. 10 is a block diagram illustrating a computer system that may be used as part of the system and method for determining a surface impedance network and a downhole impedance network in the example well system of FIGS. 1-3, according to aspects of the present disclosure. Computer system 500 may be employed to practice the concepts, methods, and techniques disclosed herein, and variations thereof. In one example approach, computer system 500 includes a plurality of components in electrical communication with each other, in some examples using a bus 503. The computing system 500 may include any suitable computer, controller, or data processing apparatus capable of being programmed to conduct the method and apparatus as further described herein.

In one example approach, computing system 500 may be a general-purpose computer, and may include a processor 501 (possibly including multiple processors, multiple cores, multiple nodes, and/or implementing multi-threading, etc.). In one such example approach, computer system 500 includes a memory 507. The memory 507 may be system memory (e.g., one or more of cache, static random-access memory (SRAM), or dynamic random-access memory (DRAM) or any one or more of the possible realizations of machine-readable media. Computer system 500 also includes bus 503 (e.g., PCI, ISA, PCI-Express, etc.) and a network interface 505 (e.g., ethernet or Fiber Channel).

The computer may also include an image processor 511 and a controller 515. The controller 515 may control the different operations that can occur in response to data received at sensor inputs 519 and/or calculations based on data received at controller 515 from the surface power supply 208 or the BHA 128. In some example approaches, controller 515 may communicate instructions to the appropriate equipment, devices, etc. used to select a desired impedance solution. Any one of the previously described functions may be partially (or entirely) implemented in hardware and/or on the processor 501. For example, the functions may be implemented with an application specific integrated circuit, in logic implemented in the processor 501, in a co-processor on a peripheral device or card, etc. Further, realizations may include fewer or additional components not illustrated in FIG. 10 (e.g., video cards, audio cards, additional network interfaces, peripheral devices, etc.). As illustrated in FIG. 8, the processor 501 and the network interface 505 are coupled to the bus 503. Although illustrated as also being coupled to the bus 503, the memory 507 may be coupled to the processor 501 only, to both processor 501 and bus 503 or to processor 501, image processor 511 and bus 503. Controller 515 may include circuitry, such as analog-to-digital (A/D) converters and buffers that allow controller 515 to receive electrical signals directly from one or more of sensor inputs 519.

In one example approach, processor 501 may be configured to execute instructions that provide control over the drilling and calibration procedures described in this disclosure, and over any equivalents thereof. For example, processor 501 may control operations of the power supply 208 or the PPD 308 during charging of the PPD 308.

With respect to computing system 500, basic features here may easily be substituted for improved hardware or firmware arrangements as they are developed. In some examples, memory 507 includes non-volatile memory and can be a hard disk or other types of computer readable media which can store data that are accessible by a computer, such as magnetic cassettes, flash memory cards, solid state memory devices, digital versatile disks (DVDs), cartridges, RAM, ROM, a cable containing a bit stream, and hybrids thereof.

It will be understood that one or more blocks of the flowchart illustrations and/or block diagrams, and combinations of blocks in the flowchart illustrations and/or block diagrams, may be implemented by program code. The program code may be provided to a processor of a general-purpose computer, special purpose computer, or other programmable machine or apparatus. As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Computer program code for carrying out operations for aspects of the disclosure may be written in any combination of one or more programming languages, including an object oriented programming language such as the Java® programming language, C++or the like; a dynamic programming language such as Python; a scripting language such as Perl programming language or PowerShell script language; and conventional procedural programming languages, such as the “C” programming language or similar programming languages. The program code may execute entirely on a stand-alone machine, may execute in a distributed manner across multiple machines, and may execute on one machine while providing results and or accepting input on another machine. While depicted as a computing system 500 or as a general-purpose computer, some example approaches can be any type of device or apparatus to perform operations described herein.

### Example Operations

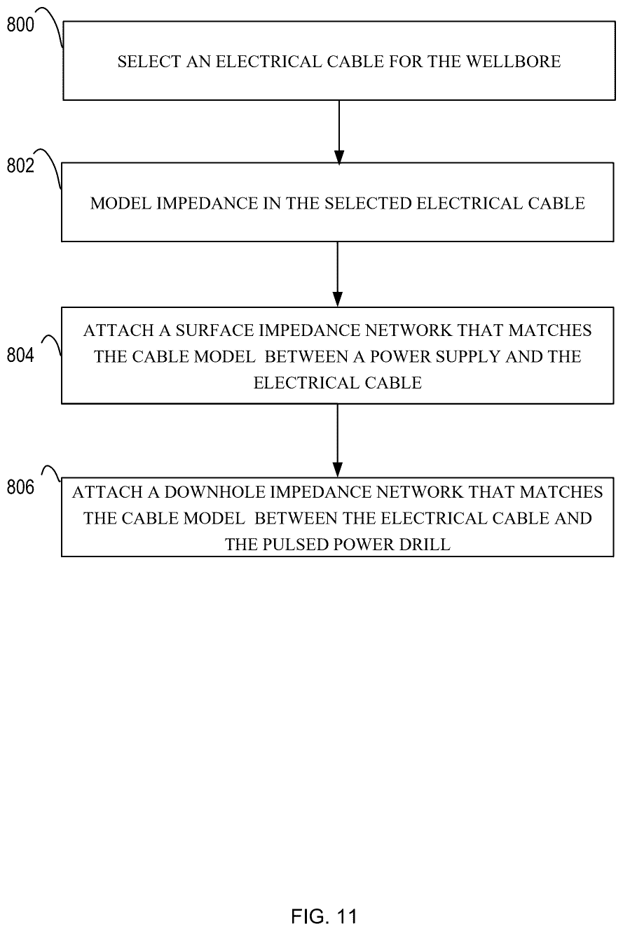

FIG. 11 is a flow chart illustrating a method of deploying a pulsed power drill, according to aspects of the present disclosure. In one example approach, an electrical cable 143 is selected for deployment between a power supply and a BHA 128 in a wellbore (800). In one example the BHA 128 includes a PPD 308. The selected electrical cable 143 is modeled for impedance, wherein the modeling is based, at least in part, on the length of the electrical cable 143 (802). In one example approach the model determines a downhole facing impedance for the uphole end of the electrical cable and an uphole facing impedance for the downhole end of the electrical cable. A surface impedance network 146 is attached between a power supply and the uphole end of the electrical cable (804). A downhole impedance network 148 is attached between the PPD 308 and the downhole end of the electrical cable 143 (806). The surface impedance network 146 has an impedance that matches the downhole facing impedance for the uphole end of the electrical cable. The downhole impedance network 148 has an impedance that matches the uphole facing impedance for the downhole end of the electrical cable.

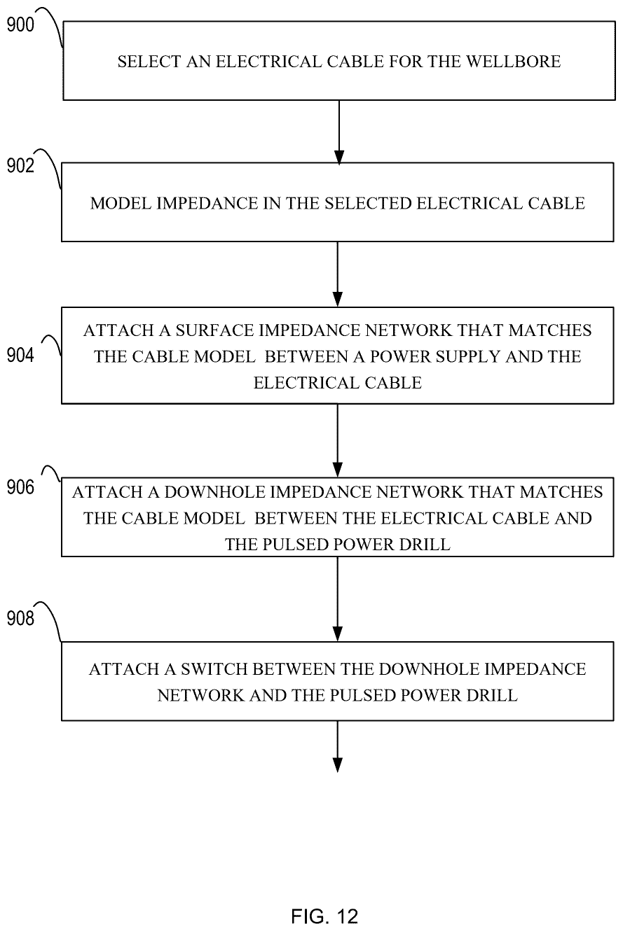

FIG. 12 is a flow chart illustrating another method of deploying a pulsed power drill, according to aspects of the present disclosure. In one example approach, an electrical cable 143 is selected for deployment between a power supply and a BHA 128 in a wellbore (900). In one example the BHA 128 includes a PPD 308. The selected electrical cable 143 is modeled for impedance, wherein the modeling is based, at least in part, on the length of the electrical cable 143 (902). In one example approach the model determines a downhole facing impedance for the uphole end of the electrical cable 143 and an uphole facing impedance for the downhole end of the electrical cable 143. A surface impedance network 146 is attached between a power supply and the uphole end of the electrical cable (904). A downhole impedance network 148 is attached between the PPD 308 and the downhole end of the electrical cable 143 (906). The surface impedance network 146 has an impedance that matches the downhole facing impedance for the uphole end of the electrical cable. The downhole impedance network 148 has an impedance that matches the uphole facing impedance for the downhole end of the electrical cable. A switch 354 is connected between the downhole impedance network and the PPD to control the transfer of power from the electrical cable 143 to the primary capacitor of the PPD 308.

Various modifications to the implementations described in this disclosure may be readily apparent to people who have ordinary skill in the art, and the generic principles defined herein may be applied to other implementations without departing from the spirit or scope of this disclosure. Thus, the claims are not intended to be limited to the implementations shown herein but are to be accorded the widest scope consistent with this disclosure, the principles and the novel features disclosed herein.

The iterative method described in this disclosure may be extended beyond drilling and applied to other contact problems such as those between a flexible beam/column/pipe/string and rigid constraints (such as drillstring-wellbore wall contacts, drillstring-riser string contacts, casing-wellbore wall contacts, sucker rod-casing contacts).

Additionally, various features that are described in this specification in the context of separate implementations can also be implemented in a single implementation. Conversely, various features that are described in the context of a single implementation can also be implemented in multiple implementations separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the implementations described above should not be understood as requiring such separation in all implementations, and it should be understood that the described program components and systems can generally be integrated together into a single software product or packaged into multiple software products. Additionally, other implementations are within the scope of the following claims. In some cases, the actions recited in the claims can be performed in a different order and still achieve desirable results.

### EXAMPLES

Example #1: A pulsed power drill well system, comprising a power supply, the power supply including a surface impedance network; a bottom hole assembly (BHA) disposed in a wellbore, the BHA having a downhole impedance network and a pulsed power drill (PPD); and an electrical cable extending through the wellbore from the surface impedance network to the downhole impedance network, the electrical cable including an upper end electrically connected through the surface impedance network to the power supply and a lower end electrically connected through the downhole impedance network to the PPD, wherein the electrical cable at the upper end has a downhole facing impedance and wherein the electrical cable at the lower end has an upward facing impedance, wherein the downhole facing impedance is modeled at least in part based on a first model of a plurality of segments of the electrical cable connected in series, wherein the uphole facing impedance is modeled at least in part based on a second model of a plurality of segments of the electrical cable connected in series, wherein the surface impedance network has an impedance that matches the downhole facing impedance of the electrical cable, and wherein the downhole impedance network has an impedance that matches the uphole facing impedance of the electrical cable.

Example #2: The pulsed power drill well system of Example #1, wherein the system further comprises a drill string extending to the BHA, the electrical cable extending through the drill string.

Example #3: The pulsed power drill well system of Example #1, wherein the system further comprises coiled tubing extending from the surface to the BHA, the electrical cable inside the coiled tubing.

Example #4: The pulsed power drill well system of Example #1, wherein the PPD includes a primary capacitor, and wherein the downhole impedance network includes a switch selectively electrically connecting the downhole impedance network to the primary capacitor, the switch closed when charging the primary capacitor.

Example #5: The pulsed power drill well system of Example #4, wherein the power supply charges the electrical cable and the downhole impedance network while the switch is open.

Example #6: The pulsed power drill well system of Example #4, wherein the downhole impedance network includes a capacitor and wherein the power supply charges the electrical cable and the downhole impedance network capacitor while the switch is open.

Example #7: The pulsed power drill well system of Example #1, wherein the PPD includes a primary capacitor and a secondary capacitor, the secondary capacitor adjacent to a pulsed power drill bit, and wherein the downhole impedance network further includes a switch selectively electrically connecting the downhole impedance network to the primary capacitor, the switch closed when charging the primary capacitor.

Example #8: The pulsed power drill well system of Example #1, wherein the surface impedance network includes an isolation switch, the isolation switch selectively electrically connecting the power supply through the surface impedance network to an uphole end of the electrical cable, the isolation switch closed when charging the electrical cable and open when discharging the electrical cable into the PPD.

Example #9: The pulsed power drill well system of Example #1, wherein the downhole facing impedance of the electrical cable is determined by treating the electrical cable as a plurality of electrical cable segments attached in series, calculating an impedance for each electrical cable segment and calculating the downhole facing impedance of the electrical cable as the impedance of each of the electrical cable segments connected in series.

Example #10: A system for coiled tubing drilling, comprising an electrical cable configured to extend from a power supply through a length of coiled tubing to a BHA, the electrical cable having a first and second end and a length; a surface impedance network electrically connected to the first end of the electrical cable; and a downhole impedance network electrically connected to the second end of the electrical cable; wherein the surface impedance network impedance matches the impedance of the electrical cable at the first end, wherein the impedance matching of the impedance of the electrical cable at the first end is downhole facing and is determined at least in part based on the length of the electrical cable, and wherein the downhole impedance network impedance matches the impedance of the electrical cable at the second end, wherein the impedance matching of the impedance of the electrical cable at the second end is uphole facing and is determined at least in part based on the length of the electrical cable.

Example #11: The electrical cable of Example #10, wherein the impedance of the electrical cable at the first end is determined by treating the electrical cable as a plurality of electrical cable segments attached in series, calculating an impedance for each electrical cable segment and calculating the impedance of the electrical cable as the impedance of each of the electrical cable segments connected in series.

Example #12: The electrical cable of Example #10, wherein the downhole impedance network includes a downhole switch and a capacitor, wherein the downhole switch when open allows the electrical cable to charge the capacitor and wherein the downhole switch when closed discharges the capacitor into a pulsed power drill (PPD) connected to the downhole impedance network.

Example #13: The electrical cable of Example #12, wherein the surface impedance network includes an isolation switch connected to the electrical cable, wherein the isolation switch opens when the downhole switch closes.

Example #14: A method including selecting an electrical cable for a wellbore, the electrical cable having a first end and a second end; modeling a downward facing impedance of the selected electrical cable at the first end of the selected electrical cable, the selected electrical cable at the first end modeled as a plurality of segments of the electrical cable, the segments connected in series; modeling an upward facing impedance of the selected electrical cable at the second end of the selected electrical cable, the selected electrical cable at the second end modeled as a plurality of segments of the electrical cable, the segments connected in series; determining a surface impedance network having an impedance that matches the modeled downward facing impedance of the selected electrical cable at the first end of the selected electrical cable; and determining a downhole impedance network having an impedance that matches the modeled upward facing impedance of the selected electrical cable at the second end of the selected electrical cable.

Example #15: The method of Example #14, wherein each electrical cable segment corresponds to an approximately 500-meter segment of the selected electrical cable.

Example #16: The method of Example #15, wherein the selected electrical cable is modeled for a coiled tubing application.

Example #17: The method of Example #15, wherein the selected electrical cable is modeled for a drill string application.

Example #18: The method of Example #14, wherein the method further comprises electrically connecting a power supply through the surface impedance network to the first end of the selected electrical cable; electrically connecting the second end of the selected electrical cable to a pulsed power drill (PPD); and charging the PPD with the power supply via the selected electrical cable.

Example #19: The method of Example #14, wherein the downhole impedance network includes a switch and a capacitor, wherein the method further comprises electrically connecting a power supply through the surface impedance network to an uphole end of the selected electrical cable; electrically connecting the downhole end of the selected electrical cable to a pulsed power drill (PPD); and charging the PPD with the power supply via the selected electrical cable, wherein charging includes opening a switch while charging a capacitor and closing the switch when charging the PPD.

Example #20: The method of Example #19, wherein the surface impedance network includes an isolation switch connected between the power supply and the electrical cable, wherein closing the switch when charging the PPD includes opening the isolation switch in the surface impedance network.

What is claimed is:

1. A pulsed power drill well system, comprising:
a power supply, the power supply including a surface impedance network;
a bottom hole assembly (BHA) disposed in a wellbore, the BHA having a downhole impedance network and a pulsed power drill (PPD); and
an electrical cable extending through the wellbore from the surface impedance network to the downhole impedance network, the electrical cable including an upper end electrically connected through the surface impedance network to the power supply and a lower end electrically connected through the downhole impedance network to the PPD, wherein the electrical cable at the upper end has a downhole facing impedance and wherein the electrical cable at the lower end has an upward facing impedance,
wherein the downhole facing impedance is modeled at least in part based on a first model of a plurality of segments of the electrical cable connected in series,
wherein the upward facing impedance is modeled at least in part based on a second model of a plurality of segments of the electrical cable connected in series,
wherein the surface impedance network has an impedance that matches the downhole facing impedance of the electrical cable, and
wherein the downhole impedance network has an impedance that matches the uphole facing impedance of the electrical cable.

2. The pulsed power drill well system of claim 1, wherein the system further comprises a drill string extending to the BHA, the electrical cable extending through the drill string.

3. The pulsed power drill well system of claim 1, wherein the system further comprises coiled tubing extending from the surface to the BHA, the electrical cable inside the coiled tubing.

4. The pulsed power drill well system of claim 1, wherein the PPD includes a primary capacitor, and
wherein the downhole impedance network includes a switch selectively electrically connecting the downhole impedance network to the primary capacitor, the switch closed when charging the primary capacitor.

5. The pulsed power drill well system of claim 4, wherein the power supply charges the electrical cable and the downhole impedance network while the switch is open.

6. The pulsed power drill well system of claim 4, wherein the downhole impedance network includes a capacitor and wherein the power supply charges the electrical cable and the capacitor of the downhole impedance network while the switch is open.

7. The pulsed power drill well system of claim 1, wherein the PPD includes a primary capacitor and a secondary capacitor, the secondary capacitor adjacent to a pulsed power drill bit, and
wherein the downhole impedance network further includes a switch selectively electrically connecting the downhole impedance network to the primary capacitor, the switch closed when charging the primary capacitor.

8. The pulsed power drill well system of claim 1, wherein the surface impedance network includes an isolation switch, the isolation switch selectively electrically connecting the power supply through the surface impedance network to an uphole end of the electrical cable, the isolation switch closed when charging the electrical cable and open when discharging the electrical cable into the PPD.

9. The pulsed power drill well system of claim 1, wherein the downhole facing impedance of the electrical cable is determined by treating the electrical cable as a plurality of electrical cable segments attached in series, calculating an impedance for each electrical cable segment and calculating the downhole facing impedance of the electrical cable as the impedance of each of the electrical cable segments connected in series.

10. A system for coiled tubing drilling, comprising:
an electrical cable configured to extend from a power supply through a length of coiled tubing to a BHA, the electrical cable having a first and second end and a length;
a surface impedance network electrically connected to the first end of the electrical cable; and
a downhole impedance network electrically connected to the second end of the electrical cable;
wherein the surface impedance network impedance matches the impedance of the electrical cable at the first end, wherein the impedance matching of the impedance of the electrical cable at the first end is downhole facing and is determined at least in part based on the length of the electrical cable, and
wherein the downhole impedance network impedance matches the impedance of the electrical cable at the second end, wherein the impedance matching of the impedance of the electrical cable at the second end is uphole facing and is determined at least in part based on the length of the electrical cable.

11. The electrical cable of claim 10, wherein the impedance of the electrical cable at the first end is determined by treating the electrical cable as a plurality of electrical cable segments attached in series, calculating an impedance for each electrical cable segment and calculating the impedance of the electrical cable as the impedance of each of the electrical cable segments connected in series.

12. The electrical cable of claim 10, wherein the downhole impedance network includes a downhole switch and a capacitor, wherein the downhole switch when open allows the electrical cable to charge the capacitor and wherein the downhole switch when closed discharges the capacitor into a pulsed power drill (PPD) connected to the downhole impedance network.

13. The electrical cable of claim 12, wherein the surface impedance network includes an isolation switch connected to the electrical cable, wherein the isolation switch opens when the downhole switch closes.

14. A method comprising:
selecting an electrical cable for a wellbore, the electrical cable having a first end and a second end;
modeling a downward facing impedance of the selected electrical cable at the first end of the selected electrical cable, the selected electrical cable at the first end modeled as a plurality of segments of the electrical cable, the segments connected in series;
modeling an upward facing impedance of the selected electrical cable at the second end of the selected electrical cable, the selected electrical cable at the second end modeled as a plurality of segments of the electrical cable, the segments connected in series;
determining a surface impedance network having an impedance that matches the modeled downward facing impedance of the selected electrical cable at the first end of the selected electrical cable; and
determining a downhole impedance network having an impedance that matches the modeled upward facing impedance of the selected electrical cable at the second end of the selected electrical cable.

15. The method of claim 14, wherein each electrical cable segment corresponds to an approximately 500-meter segment of the selected electrical cable.

16. The method of claim 15, wherein the selected electrical cable is modeled for a coiled tubing application.

17. The method of claim 15, wherein the selected electrical cable is modeled for a drill string application.

18. The method of claim 14, wherein the method further comprises:
electrically connecting a power supply through the surface impedance network to the first end of the selected electrical cable;
electrically connecting the second end of the selected electrical cable to a pulsed power drill (PPD); and
charging the PPD with the power supply via the selected electrical cable.

19. The method of claim 14, wherein the downhole impedance network includes a switch and a capacitor, wherein the method further comprises:
electrically connecting a power supply through the surface impedance network to an uphole end of the selected electrical cable;
electrically connecting the downhole end of the selected electrical cable to a pulsed power drill (PPD); and
charging the PPD with the power supply via the selected electrical cable, wherein charging includes opening a switch while charging a capacitor and closing the switch when charging the PPD.

20. The method of claim 19, wherein the surface impedance network includes an isolation switch connected between the power supply and the electrical cable, wherein closing the switch when charging the PPD includes opening the isolation switch in the surface impedance network.
